(19) United States
(12) Patent Application Publication
(10) Pub. No.: US 2007/0168142 A1
(43) Pub. Date: Jul. 19, 2007

(54) Jitter detection and reduction

(75) Inventors: Qi Pan, Didcot (GB); Joseph Barnard, London (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY LIMITED

(21) Appl. No.: 11/335,731

(22) Filed: Jan. 20, 2006

(30) Foreign Application Priority Data
Jan. 16, 2006 (GB) 0600762.9

(51) Int. Cl. G06F 19/00

(52) U.S. Cl. 702/69; 702/1; 702/66

(57) ABSTRACT

A method of detecting jitter in a digital data signal having a waveform defined by a plurality of component frequencies, including the step of comparing an indicator of the power of a selected frequency portion of the digital data signal against a reference so as to provide an indicator of the shape of the frequency-power characteristic of the data signal.

### FIELD OF THE INVENTION

The present invention relates to a technique for detecting jitter, and particularly but not exclusively for reducing jitter at a clock and data recovery device.

### BACKGROUND OF THE INVENTION

Clock and data recovery (CDR) is an important part of a digital communication system. A clock and data recovery circuit allows a distorted digital signal to be re-timed, thereby providing cleaner and sharper data to following parts of the communication system.

Clock and data recovery circuits are often used in optical communication systems. CDR circuits can be used in the transmitter of an optical system, for example between a terminal and a laser diode or electro-absorption modulator. CDR circuits are also used in the receiver of an optical system, such as between the line (optical fibre) side transimpedance amplifier (TIA) and the terminal.

Known CDR circuits can be manufactured on a single integrated circuit (IC) for integration into a module of a communication system. A typical CDR circuit on an IC comprises an oscillator, and this is often a phase locked loop (PLL). A PLL is a closed-loop feedback control system that ensures that a generated signal remains in a fixed phase relationship to a reference signal. A typical PLL comprises a phase frequency detector, a loop filter and a voltage-controlled oscillator (VCO). In a typical CDR IC, the bandwidth of the loop filter of the PLL within the CDR can be controlled through the use of external components, such as a resistor, a capacitor or a combination of a resistor and capacitor.

There is a problem that the signals produced by a CDR circuit can have “transfer jitter” introduced into them. Transfer jitter is an unwanted variation in the timing of the signals, and is detrimental to the quality of the signals. It has been observed that the amount of transfer jitter (referred to simply as “jitter” hereinafter) that is present on the output of a CDR circuit will vary with the crossing point of the input signal. In particular, as the crossing point of the input signals goes below 50%, the jitter produced by the PLL of the CDR circuit increases. In the worst case, the signal at the output of the CDR circuit may be more distorted than the signal at the input.

It has been found that the jitter present on the output of a CDR circuit can be reduced if a direct current (“DC”) input offset voltage is applied to the input signal to the CDR, whereby the magnitude of the DC offset required to reduce the jitter is related to the crossing point of the input signal. Additionally, the jitter can be reduced by controlling the loop bandwidth of the PLL circuit within the CDR, by using external components to the CDR IC.

The crossing point of the input signal can be difficult to determine for high speed data, which can typically be ˜10 Gbps. The jitter present on a signal can be measured, but typically a very expensive and bulky instrument has been required in order to measure the jitter generation. Such an instrument can obviously not be incorporated into a small transceiver module for a communication system.

### SUMMARY OF THE INVENTION

It is an aim of the present invention to provide a new technique for detecting jitter and also a technique for reducing the amount of jitter in the output of a clock and data recovery circuit.

According to an aspect of the present invention, there is provided a method of detecting jitter in a digital data signal having a waveform defined by a plurality of component frequencies, including the step of comparing an indicator of the power of a selected frequency portion of the digital data signal against a reference so as to provide an indicator of the shape of the frequency-power characteristic of the data signal.

In one embodiment, the method includes the step of comparing an indicator of the power of the data signal at a selected first frequency range about a frequency equal to the data bit rate of the data signal or a multiple thereof against an indicator of the power of the data signal at a selected frequency range lower than the first frequency range.

According to another aspect of the present invention, there is provided a method of reducing jitter in an output digital data signal generated by a signal processing device from an input digital data signal and having a waveform defined by a plurality of component frequencies, including the steps of comparing a first indicator of the power of a selected frequency portion of the output digital data signal against a reference so as to provide a second indicator of the shape of the frequency-power characteristic of the output digital data signal; and controlling the signal processing device on the basis of the second indicator so as to reduce jitter in the output digital data signal.

In one embodiment, the signal processing device is a clock and data recovery circuit.

In one embodiment, the controlling step includes applying a direct current offset voltage to the input data signal to the clock and data recovery circuit, the magnitude of the direct current offset voltage being determined on the basis of the second indicator.

In one embodiment, the clock and data recovery circuit comprises an oscillator.

In one embodiment, the controlling step includes adjusting the loop bandwidth of the oscillator on the basis of the second indicator.

In one embodiment, the step of comparing an indicator of the power of the data signal at a selected first frequency range about a frequency equal to the data bit rate of the data signal or a multiple thereof against an indicator of the power of the data signal at a selected frequency range lower than the first frequency range.

According to another aspect of the present invention, there is provided a system for reducing jitter in an output digital data signal generated by a signal processing device from an input digital data signal and having a waveform defined by a plurality of component frequencies, the system including a controller arranged to compare a first indicator of the power of a selected frequency portion of the output digital data signal against a reference so as to provide a second indicator of the shape of the frequency-power characteristic of the output digital data signal, and to control the signal processing device on the basis of the second indicator so as to reduce jitter in the output digital data signal.

In one embodiment, the signal processing device is a clock and data recovery circuit.

In one embodiment, the controller further includes a bias-T circuit for applying a direct current offset voltage to the input data signal to the clock and data recovery circuit, the magnitude of the direct current offset voltage being determined on the basis of the second indicator.

In one embodiment, the clock and data recovery circuit comprises an oscillator.

In one embodiment, the controller further includes a variable resistor for adjusting the loop bandwidth of the oscillator on the basis of the second indicator.

In one embodiment, the controller is arranged to compare an indicator of the power of the data signal at a selected first frequency range about a frequency equal to the data bit rate of the data signal or a multiple thereof against an indicator of the power of the data signal at a selected frequency range lower than the first frequency range.

In one embodiment, the selected first frequency range has a bandwidth of 10% or less than the frequency equal to the data bit rate of the data signal or a multiple thereof.

In one embodiment, the controller comprises a microprocessor.

In one embodiment, the controller comprises a closed-loop analogue control circuit.

According to another aspect of the present invention, there is provided a controller for controlling a signal processing device so as to reduce jitter in an output digital data signal generated by said signal processing device from an input digital data signal and having a waveform defined by a plurality of component frequencies, wherein the controller is arranged to compare a first indicator of the power of a selected frequency portion of the output digital data signal against a reference so as to provide a second indicator of the shape of the frequency-power characteristic of the output digital data signal, and to control the signal processing device on the basis of the second indicator so as to reduce jitter in the output digital data signal.

According to another aspect of the present invention, there is provided a computer program product comprising program code means which when loaded into a computer controls the computer to carry out the method of claim 1.

According to another aspect of the present invention, there is provided a method of reducing jitter in an output digital data signal generated by a clock and data recovery device from an input digital data signal and having a waveform defined by a plurality of component frequencies, including the steps of comparing a first indicator of the power of a selected frequency portion of the output digital data signal against a reference so as to provide a second indicator of the depth of a null in the frequency-power characteristic of the output data signal at a frequency equal to the data bit rate of the data signal or a multiple thereof.; and controlling the clock and data recovery device on the basis of the second indicator so as to reduce jitter in the output digital data signal.

According to another aspect of the present invention, there is provided a system for reducing jitter in an output digital data signal generated by a clock and data recovery device from an input digital data signal and having a waveform defined by a plurality of component frequencies, the system including a controller arranged to compare a first indicator of the power of a selected frequency portion of the output digital data signal against a reference so as to provide a second indicator of the depth of a null in the frequency-power characteristic of the output data signal at a frequency equal to the data bit rate of the data signal or a multiple thereof, and to control the clock and data recovery device on the basis of the second indicator so as to reduce jitter in the output digital data signal.

### BRIEF DESCRIPTION OF THE DRAWINGS

For a better understanding of the present invention and to show how the same may be put into effect, reference will now be made, by way of example, to the following drawings in which:

FIG. 1a shows a predicted spectrum of a PRBS signal at 10 Gbps with rise and fall times of 25 ps and rms jitter of 1.0 ps;

FIG. 1b shows a predicted spectrum of a PRBS signal at 10 Gbps with rise and fall times of 25 ps and rms jitter of 0.5 ps;

FIG. 1c shows a predicted spectrum of a PRBS signal at 10 Gbps with rise and fall times of 25 ps and rms jitter of 2.0 ps;

FIG. 1d shows a predicted spectrum of a PRBS signal at 10 Gbps with rise and fall times of 25 ps and rms jitter of 4.0 ps;

FIG. 2 shows a clock and data recovery system according to a first embodiment of the invention;

FIG. 3 shows a clock and data recovery system according to a second embodiment of the invention;

FIG. 4 shows a clock and data recovery system according to a third embodiment of the invention;

FIG. 5 shows a clock and data recovery system according to a fourth embodiment of the invention;

### DESCRIPTION OF PREFERRED EMBODIMENT

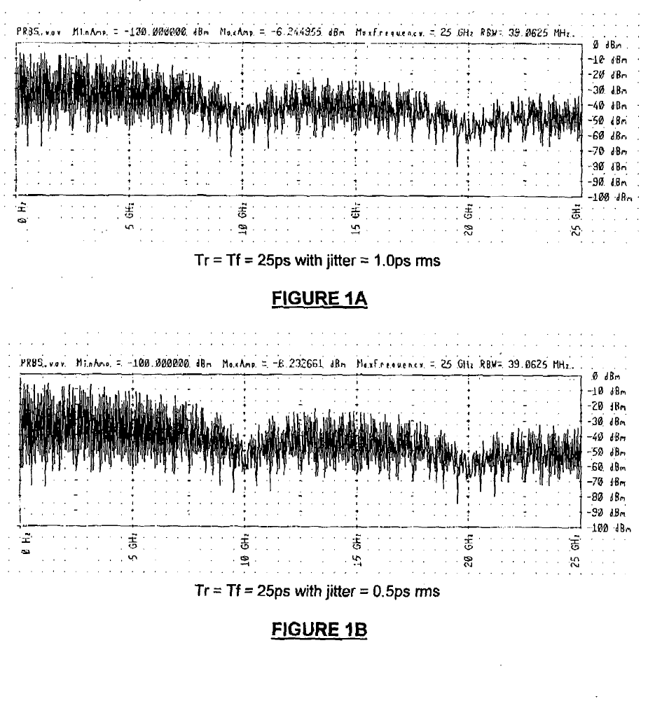

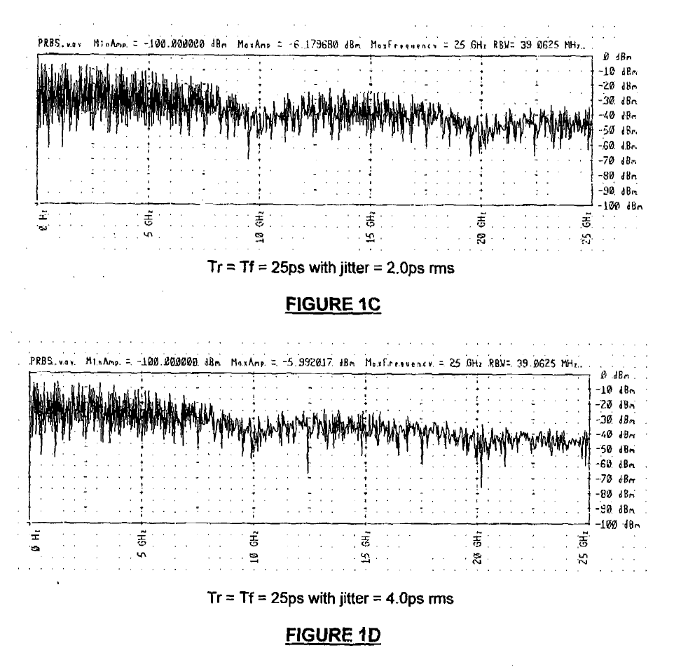

As an introduction to the description of embodiments of the invention, reference is first made to FIGS. 1a, 1b, 1c and 1d. These figures show the predicted spectrum of pseudo-random bit sequence (PRBS) signals at 10 Gbps (a typical data rate for an input signal to the CDR). The x-axis shows the frequency (in GHz) and the y-axis shows the power (in dBm). The rise and fall times (Tᵣ and T_{f}, respectively) of the PRBS signals are 25 picoseconds (“ps”). Jitter is deliberately incorporated into the PRBS signals, and the figures are for signals having different values of root mean square (rms) jitter. FIG. I a signal has an rms jitter of 1.0 ps; FIG. 1b signal has an rms jitter of 0.5 ps; FIG. 1c signal has an rms jitter of 2.0 ps; and FIG. 1d signal has an rms jitter of 4.0 ps.

As illustrated in FIGS. 1a to 1d, it has been found that the null in the spectral distribution at the bit rate (10 GHz in the figures) becomes less deep as the rms jitter level is increased. Therefore, it can be seen, for example, that the null at 10 GHz is deeper for FIG. 1b (0.5 ps rms jitter) than for FIG. 1d (4.0 ps rms jitter). A null is also present at twice the bit rate (20 GHz) and further nulls are present at other multiples of the bit rate.

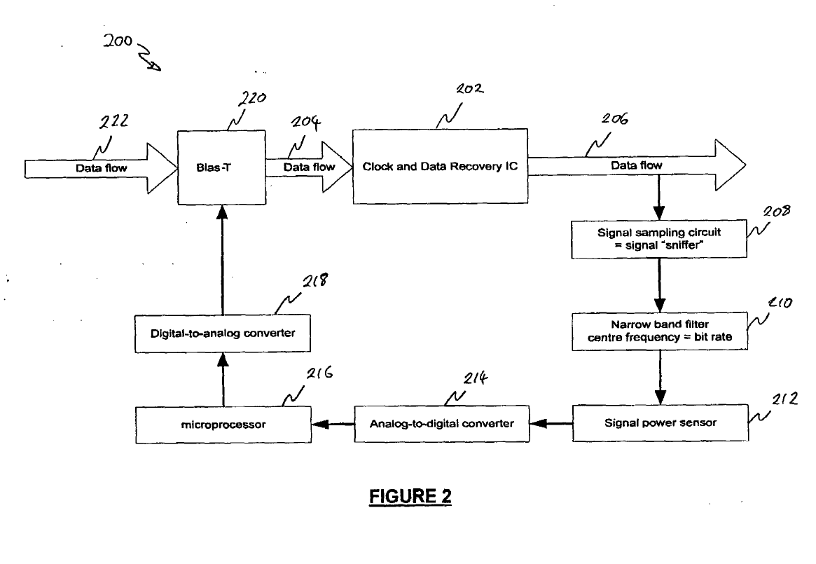

A first embodiment of a system for utilising the above technique for detecting jitter can be seen with reference to FIG. 2. This figure shows a CDR system 200 for reducing the jitter present in the output signal by adapting a DC offset applied to the input signal.

The system 200 comprises a CDR IC 202, which receives an input data signal 204, upon which a clock and data recovery process is performed to produce an output data signal 206. A signal sampling circuit 208 (also known as a signal “sniffer”) is used to extract a portion of the output signal 206 for processing. The signal from the sampling circuit 208 is passed through a narrowband filter 210. The centre frequency of the narrowband filter 210 is the bit rate of the input signal (or a multiple thereof, if an alternative null is being measured). Therefore, the narrowband filter 210 passes only the component frequencies that are present about the null shown above with reference to FIGS. 1a to 1d.

The narrowband filtered signal is provided to a signal power sensor 212, which is used to determine the power of the signal at the passband of the narrowband filter, i.e. at the bit rate frequency (or a multiple thereof). The signal power sensor is a radio frequency (RF) or microwave power sensing circuit, such as an IC, or constructed as a discrete circuit, for example using a fast diode such as a low barrier height Schottky diode. The output of the signal power sensor 212 is therefore the power level at the null shown in FIGS. 1a to 1d.

The output from the power sensor is converted to digital data using an analogue to digital converter (ADC) 214, and this digital data is provided to a microprocessor 216. The microprocessor 214 therefore has information on the power at the null in the signal spectrum, and the microprocessor 214 uses this information to derive an indication of the jitter present on the output signal 206. Using the estimate of the jitter, the microprocessor 214 determines a DC offset level that should be applied to the input to the CDR 204 in order to reduce the jitter.

The value of the DC offset determined by the microprocessor 214 is passed to a digital to analogue converter (DAC) 218 as digital data. The DAC 218 converts this digital signal to an analogue voltage level that corresponds to the desired DC offset. The DC offset voltage is then provided to a bias-T circuit 220. The bias-T circuit 220 allows a DC offset to be applied to an input data signal 222, without significantly affecting the input signal itself. The output of the bias-T circuit 220 is the data signal 204 (comprising the data component with a DC offset) that is applied to the CDR IC 202. The application of a data signal with a DC offset minimises the jitter produced by the CDR IC 202.

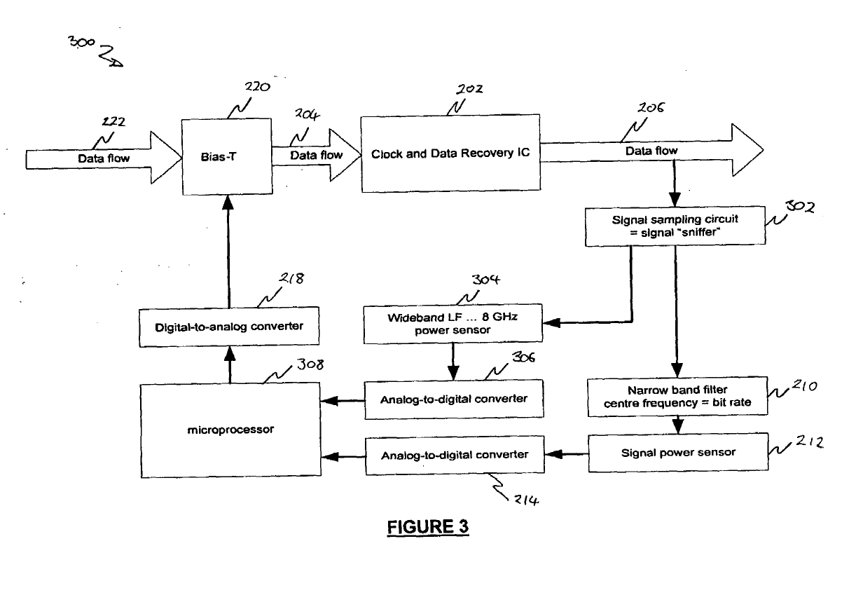

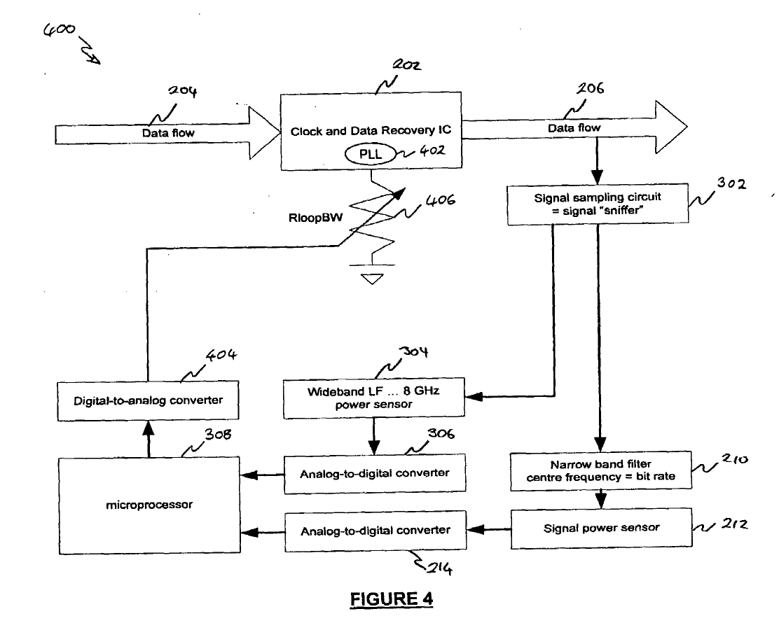

A second embodiment of the present invention is shown in FIG. 3. This figure shows a CDR system 300 with improved jitter determination. The system 300 in FIG. 3 comprises the same CDR IC 202 with a data signal input 204 and output 206 as shown previously in FIG. 2.

The output signal 206 is provided to a signal sampling circuit 302 which differs from that shown in FIG. 2 in that it produces two outputs. The first output is provided to a narrowband filter 210, signal power sensor 212 and ADC 214 in the same manner as described above with reference to FIG. 2 to provide a digital representation of the power at the null in the spectrum.

The second output of the signal sampling circuit 302 is provided to a wideband power sensor 304. The wideband power sensor 304 senses the power in the output signal over a much wider band than the power sensor 212. Typically, the wideband power sensor 304 senses the spectral power from a low frequency (LF) just above DC (i.e. close to 0 Hz) to just below the bit rate (e.g. 8 GHz in this example). The output of the wideband power sensor 304 is converted to digital data using an ADC 306.

The digital data from the two ADCs 214 and 306 are provided to a microprocessor 308, which is similar to that shown in FIG. 2, but calculates the jitter in a different manner. The microprocessor 308 compares the spectral power in the narrow band centred on the bit rate or a multiple of the bit rate (i.e. at a null in the spectrum) provided by ADC 214 with the power over a much wider band, as provided by the ADC 306. This differential or comparator-based method of measuring the jitter is an improvement over that shown in FIG. 2, as it can compensate for any variation in the amplitude of the overall signal that is output from the CDR.

The microprocessor 308 then uses the measurement of the jitter to determine a DC offset required, as described previously. The required DC offset is provided to a DAC 218, which produces an analogue voltage level that is input to a bias-T 220, and the DC level is applied to the input signal 222 in the same manner as described previously with reference to FIG. 2.

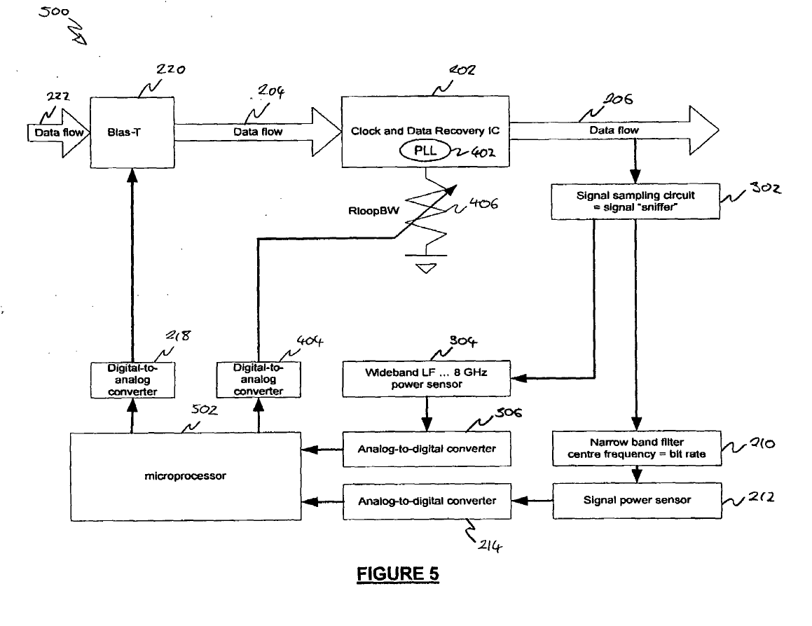

A third embodiment of the present invention is shown in FIG. 4. This figure shows a CDR system 400 in which the jitter is minimised by controlling the loop bandwidth of the PLL 402 within the CDR IC 202.

In the embodiment shown in FIG. 4, the jitter is measured and determined in the same manner as described previously with reference to FIG. 3. Once the microprocessor 308 has determined the jitter it calculates an adjustment to be made to the loop bandwidth of the PLL 402 in order to minimise the jitter. The loop bandwidth of the PLL 402 is determined by the bandwidth of the loop filter. As mentioned previously, the bandwidth of the loop filter of the PLL 402 within the CDR IC 202 is controlled by the value of external components to the CDR IC 202, such as a resistor, a capacitor or a combination of a resistor and capacitor. The microprocessor determines the adjustment required to these external component values in order to achieve the required loop bandwidth to minimise the jitter.

The microprocessor 308 outputs a digital signal to a DAC 404, which produces an analogue voltage level related to the required value of the external component controlling the loop bandwidth of the PLL 402. This analogue voltage is then provided to the component controlling the loop bandwidth. In the embodiment shown in FIG. 4, the component is a variable resistor 406, the value of which is changed depending on the value of the analogue voltage from the DAC 404. In this manner, the jitter in the CDR system 400 can be minimised by adapting the loop bandwidth.

A fourth embodiment of the present invention is shown in FIG. 5. This figure shows a CDR system 500 in which the jitter is minimised through control of both the input signal DC offset and the PLL loop bandwidth.

In the embodiment shown in FIG. 5, the jitter is measured and determined in the same manner as described previously with reference to FIG. 3. The microprocessor 502 then determines an adjustment to the DC offset applied to the input signal and/or an adjustment to the loop bandwidth of the PLL. In this way, the system 500 has maximum flexibility for minimising the jitter. The microprocessor 502 has two outputs, one for providing a signal to the DAC 218 for adjusting the DC offset, and a second for providing a signal to the DAC 404 for adjusting the value of the loop bandwidth. The manner in which the DC offset is applied is the same as that described previously with reference to FIG. 3, and the manner in which the loop bandwidth is adjusted is the same as that described previously with reference to FIG. 4.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

For example, in any of the four embodiments shown in FIGS. 2 to 5, a dedicated closed loop analogue circuit could be used in place of the microprocessor, ADCs and DACs.

What is claimed is:

1. A method of detecting jitter in a digital data signal having a waveform defined by a plurality of component frequencies, including the step of comparing an indicator of the power of a selected frequency portion of the digital data signal against a reference so as to provide an indicator of the shape of the frequency-power characteristic of the data signal.

2. A method according to claim 1, including the step of comparing an indicator of the power of the data signal at a selected first frequency range about a frequency equal to the data bit rate of the data signal or a multiple thereof against an indicator of the power of the data signal at a selected frequency range lower than the first frequency range.

3. A method of reducing jitter in an output digital data signal generated by a signal processing device from an input digital data signal and having a waveform defined by a plurality of component frequencies, including the steps of comparing a first indicator of the power of a selected frequency portion of the output digital data signal against a reference so as to provide a second indicator of the shape of the frequency-power characteristic of the output digital data signal; and controlling the signal processing device on the basis of the second indicator so as to reduce jitter in the output digital data signal.

4. A method according to claim 3, wherein the signal processing device is a clock and data recovery circuit.

5. A method according to claim 4, wherein the controlling step includes applying a direct current offset voltage to the input data signal to the clock and data recovery circuit, the magnitude of the direct current offset voltage being determined on the basis of the second indicator.

6. A method according to claim 5, wherein the clock and data recovery circuit comprises an oscillator.

7. A method according to claim 6, wherein the controlling step includes adjusting the loop bandwidth of the oscillator on the basis of the second indicator.

8. A method according to claim 3, including the step of comparing an indicator of the power of the data signal at a selected first frequency range about a frequency equal to the data bit rate of the data signal or a multiple thereof against an indicator of the power of the data signal at a selected frequency range lower than the first frequency range.

9. A system for reducing jitter in an output digital data signal generated by a signal processing device from an input digital data signal and having a waveform defined by a plurality of component frequencies, the system including a controller arranged to compare a first indicator of the power of a selected frequency portion of the output digital data signal against a reference so as to provide a second indicator of the shape of the frequency-power characteristic of the output digital data signal, and to control the signal processing device on the basis of the second indicator so as to reduce jitter in the output digital data signal.

10. A system according to claim 9, wherein the signal processing device is a clock and data recovery circuit.

11. A system according to claim 10, wherein the controller further includes a bias-T circuit for applying a direct current offset voltage to the input data signal to the clock and data recovery circuit, the magnitude of the direct current offset voltage being determined on the basis of the second indicator.

12. A system according to claim 10, wherein the clock and data recovery circuit comprises an oscillator.

13. A system according to claim 12, wherein the controller further includes a variable resistor for adjusting the loop bandwidth of the oscillator on the basis of the second indicator.

14. A system according to claim 9, wherein the controller is arranged to compare an indicator of the power of the data signal at a selected first frequency range about a frequency equal to the data bit rate of the data signal or a multiple thereof against an indicator of the power of the data signal at a selected frequency range lower than the first frequency range.

15. A system according to claim 14, wherein the selected first frequency range has a bandwidth of 10% or less than the frequency equal to the data bit rate of the data signal or a multiple thereof.

16. A system according to claim 9, wherein the controller comprises a microprocessor.

17. A system according to claim 9, wherein the controller comprises a closed-loop analogue control circuit.

18. A controller for controlling a signal processing device so as to reduce jitter in an output digital data signal generated by said signal processing device from an input digital data signal and having a waveform defined by a plurality of component frequencies, wherein the controller is arranged to compare a first indicator of the power of a selected frequency portion of the output digital data signal against a reference so as to provide a second indicator of the shape of the frequency-power characteristic of the output digital data signal, and to control the signal processing device on the basis of the second indicator so as to reduce jitter in the output digital data signal.

19. A computer program product comprising program code means which when loaded into a computer controls the computer to carry out the method of claim 1.

20. A method of reducing jitter in an output digital data signal generated by a clock and data recovery device from an input digital data signal and having a waveform defined by a plurality of component frequencies, including the steps of comparing a first indicator of the power of a selected frequency portion of the output digital data signal against a reference so as to provide a second indicator of the depth of a null in the frequency-power characteristic of the output data signal at a frequency equal to the data bit rate of the data signal or a multiple thereof.; and controlling the clock and data recovery device on the basis of the second indicator so as to reduce jitter in the output digital data signal.

21. A system for reducing jitter in an output digital data signal generated by a clock and data recovery device from an input digital data signal and having a waveform defined by a plurality of component frequencies, the system including a controller arranged to compare a first indicator of the power of a selected frequency portion of the output digital data signal against a reference so as to provide a second indicator of the depth of a null in the frequency-power characteristic of the output data signal at a frequency equal to the data bit rate of the data signal or a multiple thereof, and to control the clock and data recovery device on the basis of the second indicator so as to reduce jitter in the output digital data signal.
